(19) United States
(12) Patent Application Publication
(10) Pub. No.: US 2007/0158957 A1
(43) Pub. Date: Jul. 12, 2007

(54) Double door security device

(76) Inventors: Robert E. Kramer, Vero Beach, FL (US); Anthony Lepore, Vero Beach, FL (US); Terry M. Kramer, Delaware, OH (US)

Correspondence Address: LITMAN LAW OFFICES, LTD., P.O. BOX 15035, CRYSTAL CITY STATION, ARLINGTON, VA, 22215, US

(21) Appl. No.: 11/486,058

(22) Filed: Jul. 14, 2006

Related U.S. Application Data
(60) Provisional application No. 60/753,725, filed on Dec. 27, 2005.

(51) Int. Cl. E05C 19/00

(52) U.S. Cl. 292/259 R

(57) ABSTRACT

The double door security device uses at least two opposed hinges of the double door pair to secure corresponding door bar retainers to the door frame structure. The hinge pin is removed and the door bar retainer is placed upon the hinge, with a hinge pin of suitable length reinstalled through the hinge to secure the door bar retainer pivotally to the hinge. The door bar retainer, in combination with the hinge, defines a door bar passage for the removable installation of a door bar therethrough. The retainers may be configured to accept door bars having various cross sectional shapes, e.g. two by four lumber, square and round tubing and pipe, etc. The hinge attachment ends of the retainers are preferably beveled to minimize marring of the door and door frame adjacent to the hinge, and to serve as a door stop limiting the opening swing of the door.

### REFERENCE TO RELATED PATENT APPLICATION

This application claims the benefit of U.S. Provisional Patent Application Ser. No. 60/753,725, filed on Dec. 27, 2005.

### BACKGROUND OF THE INVENTION

1. Field of the Invention

The present invention relates generally to mechanical security devices for openings in building structures. More specifically, the present security device comprises at least two opposed door bar keepers or retainers adapted for attachment to the opposite hinges of a double door system, and removably retaining at least one door bar thereacross to secure the double doors as desired.

2. Description of the Related Art

Door bars are well known for preventing the opening of a door. Such bars were the first security system developed for doorway entrances into structures, with keyed locks and the like not being developed, or at least not being economically available to most persons, until later times. While the door bar principle has its disadvantages, e.g. the structure must be occupied or at least accessible from inside in order to install and remove the door bar, it is nevertheless still the strongest doorway security system possible.

Conventionally, door bars have required brackets or retainers secured into the wall structure to each side of the door. The need for a solid anchor or attachment for the brackets requires that the brackets be attached to some solid structure to each side of the doorway, e.g. to the door frame, etc. Simple drywall anchors or the like threaded into the relatively fragile wall paneling conventionally used to finish the interior of a structure, do not provide nearly enough strength to resist tearing out in the event of strong forces applied to the door from the opposite side. As a result, the effort involved in the proper installation of the door bar retaining brackets to each side of a doorway, can be considerable.

Double doors, i.e. door sets having opposite hinged edges secured to the opposite sides of the door frame opening, are particularly vulnerable to breakdown from outside, whether from forced entry or from extreme weather conditions. This is due to the relatively weak central security between the two doors, with there generally being relatively small upper and lower pins extending from one door and a conventional latch and striker assembly between the doors. Relatively little force is required to break such a system, in comparison to a single hinged door having a latch engaging a striker receptacle in the door frame.

However, all hinged doors, whether single or double, are provided with anchors which are solidly attached to the adjacent door opening, in the form of their hinges. The hinges are attached to the door frame structure, and their attachment screws in both the door frame and the door are placed in shear when force is applied to push the door into the door opening. This results in an extremely strong attachment which is already in place in all hinged doors. In the case of double doors, such hinge attachments are provided on each side of the door opening. The present invention provides a means of using the existing hinges in a double door installation for securing door bar retaining brackets thereto, thus avoiding need for extensive labor and effort in anchoring additional retainer brackets adjacent the door opening.

The present inventors are aware of various door bar security systems which have been developed in the past. An example of such is found in French Patent Publication No. 2,554,495, published on May 10, 1985 to Laurent Reichenecker. According to the drawings and English abstract, the device comprises a bar pivotally attached to the door with a keeper or retainer anchored to each side of the door opening and engaging the ends of the bar when the bar is pivoted to a horizontal position. No means for securing the retainers to the existing hinges is disclosed.

Another example is found in German Patent Publication No. 4,237,061 published on Jan. 5, 1994 to Harry Schmidt et al. According to the drawings and English abstract, the device comprises a bar having at least one threaded end which engages a retainer. Two opposed retainers are positioned to opposite sides of the door opening, and the bar is installed therebetween. The bar is rotated to advance it away from the threaded retainer, thereby wedging the bar and retainers across the span of the doorway. No permanent mechanical attachment either to the hinges or to any other structure is provided for the bar retainers in this device.

None of the above inventions and patents, taken either singly or in combination, is seen to describe the instant invention as claimed. Thus, a double door security device solving the aforementioned problems is desired.

### SUMMARY OF THE INVENTION

The double door security device comprises at least a pair of opposed door bar retainers or brackets which are anchored to corresponding pairs or sets of hinges in a double door installation. The brackets are secured to the hinges by hinge pins which secure the two leaves of each hinge together and also hold each bracket in place on the corresponding hinge. The brackets extend outwardly from the hinges to define door bar passages between the brackets and corresponding hinges. A door bar is removably installed through the door bar passages and across the double doors, to secure the doors against inward opening against the bar. The brackets or retainers may be configured for any practicable cross sectional bar shape, and brackets may be secured across more than one hinge set for additional security, if so desired. The brackets are preferably beveled at their hinge pin attachment ends, in order to reduce marring of the door and trim surfaces adjacent the hinges and further to serve as a stop to limit the swing of the door to a predetermined opening.

These and other features of the present invention will become readily apparent upon further review of the following specification and drawings.

### BRIEF DESCRIPTION OF THE DRAWINGS

FIG. 1 is an environmental, perspective view of a double door security device according to the present invention, showing its installation across a pair of double doors.

FIG. 2 is an exploded detail perspective view showing the assembly of a door bar retainer of the present invention to a door hinge, with alternative hinge pins being shown.

FIG. 3 is a detailed top plan view of a single hinge and retainer installation according to the present invention, showing the beveled hinge pin attachment ends of the retainer and the door swing opening limit provided thereby.

FIG. 4 is a side elevation view of a pair of door bar retainers having different configurations installed upon the first and second hinges of a door installation.

FIG. 5 is another side elevation view of another pair of door bar retainers having different configurations from one another, installed upon the first and second hinges of a door installation.

Similar reference characters denote corresponding features consistently throughout the attached drawings.

### DETAILED DESCRIPTION OF THE PREFERRED EMBODIMENTS

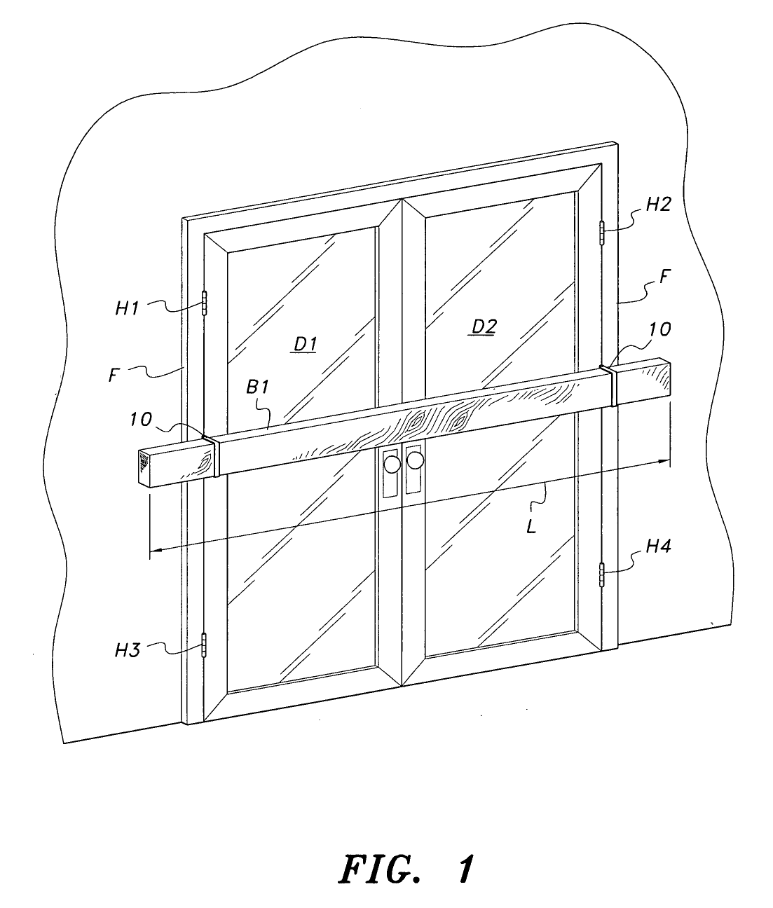

The present invention comprises various embodiments of a security device or assembly for securing a bar across the span or width of a set of double doors, generally as shown in FIG. 1 of the drawings. Double door sets by definition include opposed first and second doors, e.g. doors D1 and D2 of FIG. 1, hingedly secured to the sides of the door frame F by a series of hinge assemblies, e.g. hinge assemblies H1, H2, H3, H4, etc. In an exterior doorway having double doors, a series of three such hinge assemblies is typically used to attach each door D1 and D2 to opposite sides of the door frame F. The central hinge assemblies are concealed by the present invention and by a door bar B1 secured therein, in FIG. 1.

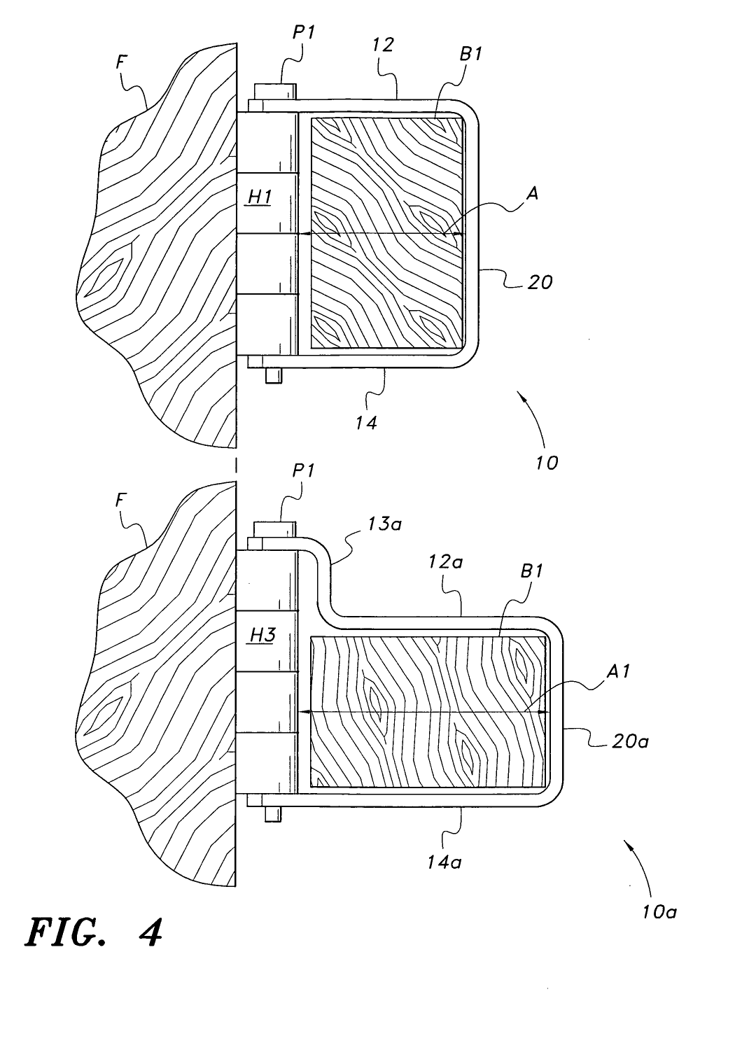

The present invention includes at least one first door bar retainer and at least one second door bar retainer, with each first and second door bar retainer comprising a pair of identical retainers in any given installation. The door bar retainers of FIGS. 1, 2, 3, and the upper retainer of the two retainers shown in FIG. 4. are identical in configuration, and are all designated by the reference numeral 10 throughout the drawings. A door bar retainer 10 (and/or other door bar retainer configuration shown in the drawings and discussed further below) is removably secured to the corresponding hinge assembly to each side of the double door installation, and a door bar B1 of appropriate configuration and length L sufficient to extend at least slightly beyond the span defined by the opposed door bar retainers is removably installed through the door bar passages defined by the door bar retainers and their hinges.

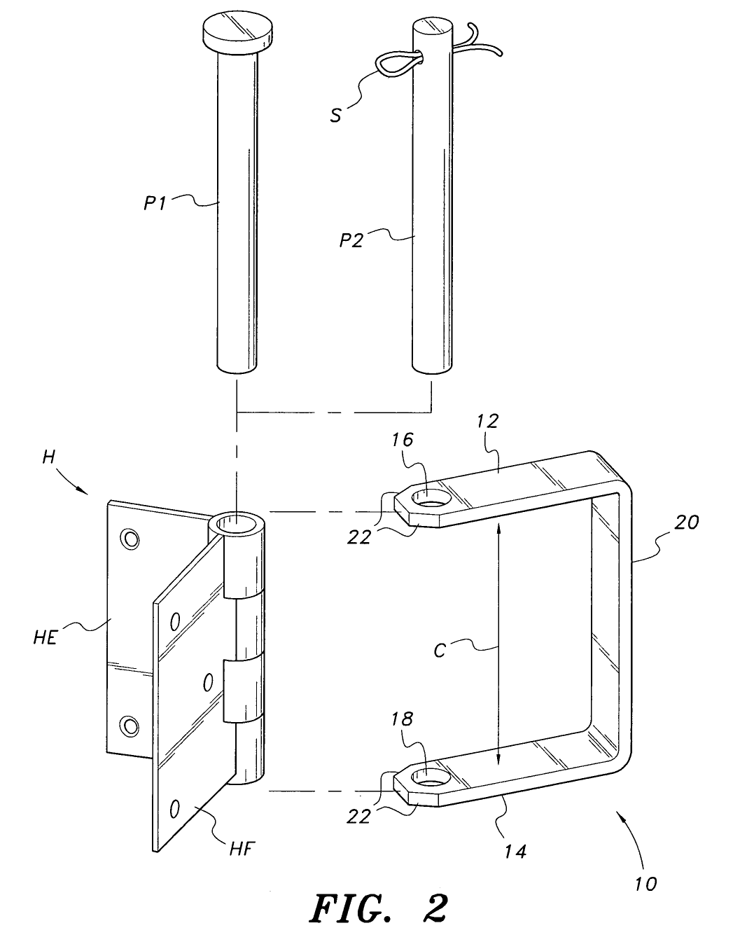

FIG. 2 provides a detailed exploded perspective view of the installation of a door bar retainer 10 to a door hinge assembly H, as would be used in any of the hinge installations H1, H2, H3, etc. of FIG. 1. Each door hinge assembly H comprises a door frame hinge element HF for attaching to the door frame and a door edge hinge element HE which is attached to the edge of the door. The two hinge elements HF and HE are interposed with one another and are secured together by a hinge pin, e.g. headed pin P1 of FIG. 2, or alternatively a pin P2 having a diametric passage formed therethrough with a stop pin S (cotter pin, roll pin, wire, small diameter bolt or screw, etc.) installed therein. The integral head of the pin P1 and the stop pin S of the pin P2 serve as stop means to prevent the hinge pins P1 or P2 from falling through the hinge passage defined by the two interposed hinge elements HF and HE.

The door bar retainer 10 is formed of an elongate flat strip of metal and bent for installation on the corresponding hinge assembly, generally as shown in FIG. 2. Each door bar retainer 10 includes opposite first and second attachment end portions, respectively 12 and 14, which are bent to lie parallel to one another and which define a door bar channel C therebetween. Each of the two attachment end portions 12 and 14 includes a distal hinge pin passage, respectively 16 and 18, formed therethrough, with the hinge pin P1 or P2 passing through the hinge pin passage 16 and 18 and through the interposed hinge elements HE, HF to secure the door bar retainer 10 to the hinge assembly H. Each door bar retainer 10 includes a medial portion 20 having a span or length essentially equal to the height of the hinge assembly H. The two attachment end portions 12 and 14 of the door bar retainer 10 span the interposed portions of the hinge elements HE and HF, with the hinge pin P1 or P2 having sufficient length to pass through the interposed hinge elements and through the two hinge pin passages 16 and 18 of the attachment end portions 12 and 14 of the door bar retainer 10 when installed. The medial portion 20 and opposite attachment end portions 12 and 14 of the door bar retainer 10, along with the interposed portions of the hinge assembly H, define a door bar passage A for the removable installation of a door bar, e.g. door bar B1, therein, as shown in FIG. 4.

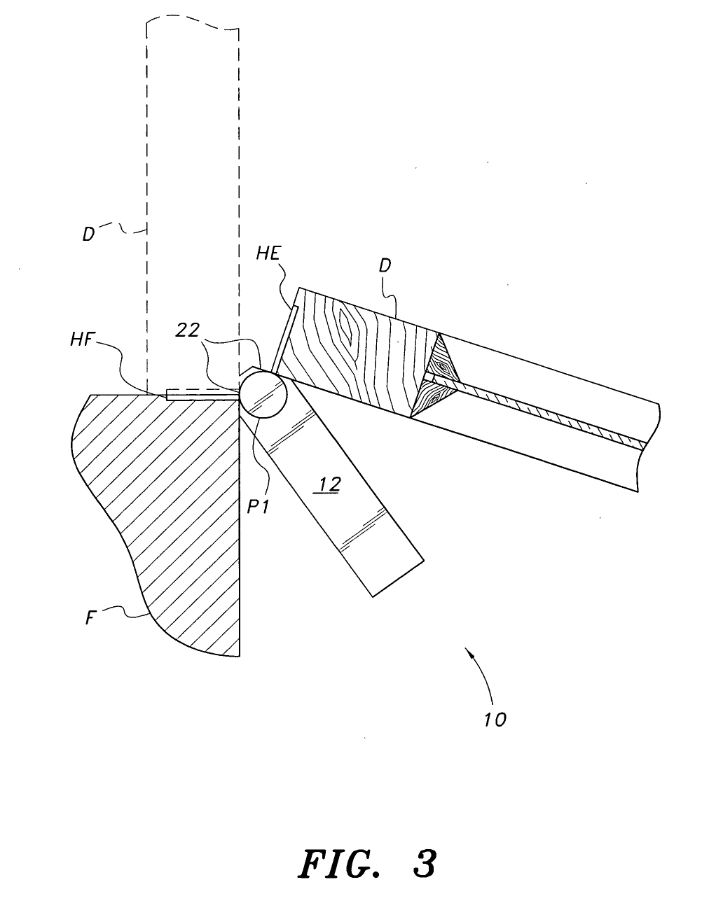

It will be noted that the corners 22 of the distal ends of the end attachment portions 12 and 14 of the door bar retainer 10 are beveled. This provides certain advantages and benefits in an installation, as shown in FIG. 3. FIG. 3 provides a top plan view of an exemplary door bar retainer installation to a hinge assembly H, with the hinge assembly having a door frame hinge element HF secured to the door frame F and a door edge hinge element HE attached to the edge of the door D. The assembly is secured together by a hinge pin P1, with the head of the pin being visible in the top plan view of FIG. 3. It will be noted that the beveled corners 22 of the end attachment portions, e.g. the upper attachment portion 12 shown in FIG. 3, provide clearance for the door D to swing open, and also serve as a stop means to prevent excessive opening of the door. The beveled flats also spread the contact pressure of the door surface against the door bar retainer 10 and pressure of the retainer against the door frame F, thereby minimizing marring of those surfaces.

FIG. 4 provides an end elevation view of two exemplary door bar retainer installations to vertically adjacent hinge assemblies in a door installation. While normally it is anticipated that only a single door bar would be installed across two horizontally opposed door bar retainers installed upon corresponding horizontally opposed hinges, FIG. 4 illustrates the concept of multiple retainers installed upon each side of the door, and also illustrates different configurations or embodiments of door bar retainers as well.

The upper hinge assembly H1 includes a generally rectangular door bar retainer 10 installed thereon, with the medial portion 20 of the retainer having a height or span essentially equal to the height or span of the hinge assembly H and the two substantially equal length arms or end portions 12 and 14 defining a generally rectangular door bar passage A, suitable for a door bar B1 comprising a conventional “two by four” or “two by six” wood stud or the like.

The lower hinge H3 of FIG. 4 includes an alternate embodiment door bar retainer 10a installed thereon. The door bar retainer 10a includes a somewhat longer lower or second attachment end portion 14a, and a somewhat shorter intermediate portion 20a. The first or upper end portion 12a includes an offset portion 13a therein, to allow for the difference in span between the two distal ends of the attachment portions 12a and 14a and the shorter span of the intermediate portion 20a. This configuration defines a lower but wider rectangular door bar passage A1 therein, providing for the installation of a rectangular door bar B1 with its major width or thickness oriented horizontally and its minor width or thickness oriented vertically, i.e. ninety degrees to the orientation shown with the door bar retainer 10 installation on the upper hinge assembly H1 in FIG. 4. The greater horizontal thickness of the door bar B1 in the lower portion of FIG. 4 provides greatly increased resistance to bending and shear, and thus a stronger installation, in comparison to the configuration of the door bar retainer 10 of the upper portion of FIG. 4. While the lower or second attachment end portion 14a is straight and the upper or first attachment end portion 12a has an offset portion 13a, it will be seen that the retainer 10a may be inverted from the orientation shown in the lower portion of FIG. 4, if so desired. This may allow the location of the door bar B1 to be adjusted slightly to clear any door hardware, etc. which may protrude from the door and into the path of the door bar B1.

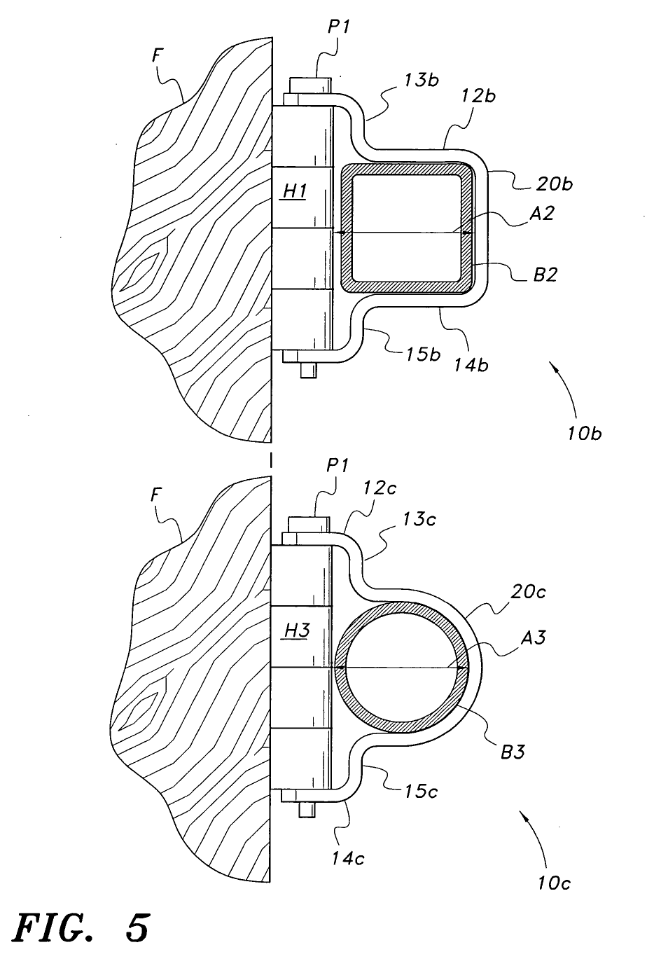

FIG. 5 provides an end elevation view of two additional door bar retainer embodiments installed upon vertically adjacent hinge assemblies H1 and H3 on a door frame F. The door bar retainer 10b of the upper portion of FIG. 5 includes offsets, respectively 13b and 15b, in both the first or upper and second or lower attachment ends 12b and 14b. The medial portion 20b of the retainer 10b is shortened correspondingly. This configuration provides a somewhat smaller door bar passage A2, configured to hold a door bar B2 of square section steel pipe or tube, or perhaps a solid bar, of somewhat smaller cross sectional dimensions than the wood bar B1 of FIGS. 1 and 4. The steel door bar B2 can still provide at least the same strength as the wood bar B1, even with the smaller cross sectional dimensions of the steel bar B2, depending upon its size relative to the wood bar B1.

The door bar retainer 10c shown installed upon the lower hinge assembly H3 in the lower portion of FIG. 5 illustrates still another configuration or embodiment. The door bar retainer 10c includes first and second offset portions, respectively 13c and 15c, formed in the corresponding first and second hinge attachment ends 12c and 14c. The medial portion 20c has a semicircular shape, connecting the two offset portions 13c and 15c of the device and defining a semicircular door bar passage A3. This configuration is suited for the use of a door bar B3 comprising a length of steel pipe or the like having a circular cross section. Again, the steel pipe door bar B3 may have a smaller cross sectional dimension or diameter than a wood bar of equivalent strength, depending upon the wall thickness or schedule of the pipe.

In conclusion, the present double door security device provides a much needed means of positively securing both doors of a double door installation against unwanted entry, etc. The present security device makes use of the existing conventional hinge installation to each side of the door frame opening and to each of the doors, requiring only a slightly longer hinge pin at each door bar retainer to secure the retainer to the hinge assembly. Not only is this installation generally superior in strength to many other door bar retainer installations, but it is also considerably faster and easier to install. A number of different retainer configurations may be provided, corresponding to different cross sectional dimensions and shapes for the door bar to be used. Additional strength and security may be provided by installing multiple door bar retainers along each side of the door opening, and using multiple door bars. It will also be recognized that the present security device is readily adaptable to virtually any form of panels installed upon opposed hinges, e.g. window shutters, etc. Accordingly, the present double door security device will prove to be a most welcome accessory wherever double doors, shutters, etc. are installed.

It is to be understood that the present invention is not limited to the embodiments described above, but encompasses any and all embodiments within the scope of the following claims.

We claims:

1. A double door security device for attachment to at least one first side and at least one second side hinge and hinge pin assembly of a double door installation in a door frame, the security device comprising:
at least one first side and at least one second side door bar retainer, each formed of an elongate flat strip of metal having mutually opposed first and second hinge attachment end portions;
each of the end portions being bent parallel to one another and defining a door bar channel therebetween, adapted to removably receive a door bar therethrough; and
each of the end portions further having a distal hinge pin passage formed therethrough, the passages providing for attachment of the door bar retainer to the corresponding hinge by means of the hinge pin of the assembly.

2. The double door security device according to claim 1, further including:
at least one first side and at least one second side door frame hinge element;
at least one first side and at least one second side door edge hinge element, interposed with the corresponding door frame hinge element; and
at least one first side hinge pin and at least one second side hinge pin securing the corresponding door frame hinge element, door edge hinge element, and door bar retainer together with the end portions of the door bar retainer capturing the hinge elements therebetween, each corresponding door frame hinge element, door edge hinge element, and door bar retainer defining a door bar passage therebetween.

3. The double door security device according to claim 2, further including at least one door bar having a length greater than the span defined by the first side and second side door bar retainer, removably installed in the door bar channels of the first side and second side door bar retainer and securing the double door installation when installed.

4. The double door security device according to claim 3, wherein:
said at least one first side and at least one second side door bar retainer comprises a plurality of first side and second side door bar retainers;
said at least one first side and at least one second side door frame hinge element comprise a plurality of first side and second side door frame hinge elements;
said at least one first side and at least one second side door edge hinge element comprise a plurality of first side and second side door edge hinge elements;
said at least one first side hinge pin and at least one second side hinge pin comprise a plurality of first side hinge pins and second side hinge pins; and
said at least one door bar comprises a plurality of door bars.

5. The double door security device according to claim 2, wherein each door bar passage has a generally rectangular cross sectional shape.

6. The double door security device according to claim 2, wherein each door bar passage has a generally semicircular cross sectional shape.

7. The double door security device according to claim 2, wherein each said hinge pin further includes a stop selected from the group consisting of an integral head and a diametric passage having a pin installed therethrough.

8. The double door security device according to claim 1, further including mutually opposed bevels distally disposed at each of the hinge attachment end portions of each of said door bar retainers, the bevels precluding damage to adjacent door and door frame structure and defining door stop opening limits.

9. A double door security device and at least one first side and at least one second side hinge and hinge pin assembly for a double door installation in a door frame, the security device and hinge and hinge pin assemblies comprising in combination:
at least one first and at least one second door bar retainer, each formed of an elongate flat strip of metal having opposite first and second hinge attachment end portions;
each of the end portions being bent parallel to one another and defining a door bar channel therebetween;
each of the end portions further having a distal hinge pin passage formed therethrough, adapted for attachment to the hinge by the hinge pin of the assembly;
at least one first side and at least one second side door frame hinge element;
at least one first side and at least one second side door edge hinge element, interposed with the corresponding door frame hinge element; and
at least one first side hinge pin and at least one second side hinge pin securing the corresponding door frame hinge element, door edge hinge element, and door bar retainer together with the end portions, of the door bar retainer capturing the hinge elements therebetween, each corresponding door frame hinge element, door edge hinge element, and door bar retainer defining a door bar passage therebetween.

10. The double door security device according to claim 9, wherein each door bar passage has a generally rectangular cross sectional shape.

11. The double door security device according to claim 9, wherein each door bar passage has a generally semicircular cross sectional shape.

12. The double door security device according to claim 9, wherein each said hinge pin further includes a stop selected from the group consisting of an integral head and a diametrically drilled passage having a pin installed therethrough.

13. The double door security device according to claim 9, further including at least one door bar having a length greater than the span defined by the first side and second side door bar retainer, removably installed in the door bar channels of the first side and second side door bar retainer and securing the double door installation when installed.

14. The double door security device according to claim 13, wherein:
said at least one first side and at least one second side door bar retainer comprises a plurality of first side and second side door bar retainers;
said at least one first side and at least one second side door frame hinge element comprise a plurality of first side and second side door frame hinge elements;
said at least one first side and at least one second side door edge hinge element comprise a plurality of first side and second side door edge hinge elements;
said at least one first side hinge pin and at least one second side hinge pin comprise a plurality of first side hinge pins and second side hinge pins; and
said at least one door bar comprises a plurality of door bars.

15. The double door security device according to claim 9, further including mutually opposed bevels distally disposed at each of the hinge attachment end portions of each of said door bar retainers, the bevels precluding damage to adjacent door and door frame structure and defining door stop opening limits.

16. A double door security device and at least one first side and at least one second side hinge and hinge pin assembly for a double door installation in a door frame, the security device and hinge and hinge pin assemblies comprising in combination:
at least one first and at least one second door bar retainer, each formed of an elongate flat strip of metal having opposite first and second hinge attachment end portions;
each of the end portions being bent parallel to one another and defining a door bar channel therebetween;
each of the end portions further having a distal hinge pin passage formed therethrough, adapted for attachment to the hinge by the hinge pin of the assembly;
at least one first side and at least one second side door frame hinge element;
at least one first side and at least one second side door edge hinge element, interposed with the corresponding door frame hinge element;
at least one first side hinge pin and at least one second side hinge pin securing the corresponding door frame hinge element, door edge hinge element, and door bar retainer together with the end portions of the door bar retainer capturing the hinge elements therebetween, each corresponding door frame hinge element, door edge hinge element, and door bar retainer defining a door bar passage therebetween; and
at least one door bar having a length greater than the span defined by the first side and second side door bar retainer, removably installed in the door bar passages of the first side and second side door bar retainer and corresponding hinge elements and securing the double door installation when installed.

17. The double door security device according to claim 16, wherein:
said at least one first side and at least one second side door bar retainer comprises a plurality of first side and second side door bar retainers;
said at least one first side and at least one second side door frame hinge element comprise a plurality of first side and second side door frame hinge elements;
said at least one first side and at least one second side door edge hinge element comprise a plurality of first side and second side door edge hinge elements;
said at least one first side hinge pin and at least one second side hinge pin comprise a plurality of first side hinge pins and second side hinge pins; and
said at least one door bar comprises a plurality of door bars.

18. The double door security device according to claim 16, wherein each door bar passage has a cross sectional shape selected from the group consisting of generally rectangular and generally semicircular cross sectional shapes.

19. The double door security device according to claim 16, wherein each said hinge pin further includes a stop selected from the group consisting of an integral head and a diametrically drilled passage having a pin installed therethrough.

20. The double door security device according to claim 16, further including mutually opposed bevels distally disposed at each of the hinge attachment end portions of each of said door bar retainers, the bevels precluding damage to adjacent door and door frame structure and defining door stop opening limits.
